(19) United States
(12) Patent Application Publication
(10) Pub. No.: US 2024/0330879 A1
(43) Pub. Date: Oct. 3, 2024

(54) LOCATION-BASED PROACTIVE ALERT TRANSMISSION FOR AUTOMATED TELLER MACHINES

(71) Applicant: Truist Bank, Charlotte, NC (US)

(72) Inventors: Ronald Lee Ratcliffe, JR., Garner, NC (US); Reinaldo Gamaliel Rivera Colon, Raleigh, NC (US)

(73) Assignee: Truist Bank, Charlotte, NC (US)

(21) Appl. No.: 18/128,286

(22) Filed: Mar. 30, 2023

(51) Int. Cl. G06Q 20/10; G08B 21/18

(52) U.S. Cl. CPC G06Q 20/1085; G08B 21/18

(57) ABSTRACT

Features described herein generally relate to automatically transmitting alerts related to Automated Teller Machine (ATM) accessibility to user devices. For example, a system may detect, based on a location associated with a user device, an ATM associated with the user device. The system may further determine that the ATM will be inaccessible for a subsequent timeframe. Additionally, the system may transmit, to the user device, an alert to notify a user of the user device that the ATM will be inaccessible. The alert can include a first indication of the ATM and a second indication of the subsequent timeframe.

### TECHNICAL FIELD

The present disclosure relates generally to location-based monitoring and alerting and, more particularly (although not necessarily exclusively), to location-based and proactive transmission of alerts related to automated teller machine accessibility.

### BACKGROUND

A service provider can resolve service events for users at a location associated with the service provider. For example, a user can wait in a queue at the location to have a service event resolved by authorized personnel. However, waiting in the queue can be time-consuming. Thus, it can be desirable to automate the service events, such as by implementing automated teller machines (ATMs). The users can interact with the ATMs, to cause the ATMs to perform functions (e.g., the service events). For example, the users can interact with the ATMs to cause the ATMs to withdraw funds, deposit funds, transfer funds, or perform other suitable service events.

Additionally, the location associated with the service provider may be closed during particular timeframes, while the ATMs may be accessible during most timeframes. But, the ATMs may be occasionally offline or otherwise inaccessible, such as due to maintenance or malfunctions. Current systems for indicating that an ATM is offline or otherwise inaccessible can require that a user access a software application or web interface, search for the ATM, and check for a status of the ATM, which can also be time-consuming. Therefore, there can be a need to improve an efficiency of indicating ATM accessibility to users.

### SUMMARY

According to one example of the present disclosure, a system can include a processor and a memory including instructions that are executable by the processor to perform operations. The operations can include detecting, based on a location associated with a user device, at least one automated teller machine (ATM) associated with the user device. The operations can also include determining that the at least one ATM will be inaccessible for a subsequent timeframe. The operations can further include transmitting, to the user device, an alert to notify a user of the user device that the at least one ATM will be inaccessible. The alert can include a first indication of the at least one ATM and a second indication of the subsequent timeframe.

According to another example of the present disclosure, a non-transitory computer-readable medium may contain instructions that are executable by a processor to cause the processor to perform operations. The operations can include detecting, based on a location associated with a user device, at least one ATM associated with the user device. The operations can also include determining that the at least one ATM will be inaccessible for a subsequent timeframe. The operations can further include transmitting, to the user device, an alert to notify a user of the user device that the at least one ATM will be inaccessible. The alert can include a first indication of the at least one ATM and a second indication of the subsequent timeframe.

According to a further example of the present disclosure, a computer-implemented method includes detecting, based on a location associated with a user device, at least one ATM associated with the user device. The computer-implemented method can also include determining that the at least one ATM will be inaccessible for a subsequent timeframe. The computer-implemented method can further include transmitting, to the user device, an alert to notify a user of the user device that the at least one ATM will be inaccessible. The alert can include a first indication of the at least one ATM and a second indication of the subsequent timeframe.

### BRIEF DESCRIPTION OF THE DRAWINGS

FIG. 1 is a block diagram of an example of a system for automatically transmitting alerts related to automated tell machine (ATM) accessibility according to one example of the present disclosure.

FIG. 2 is a block diagram of an example of a computing device for automatically transmitting alerts related to ATM accessibility according to one example of the present disclosure.

FIG. 3 is a flowchart of a process for automatically transmitting alerts related to ATM accessibility according to one example of the present disclosure.

FIG. 4 is a flowchart of a process for using a machine-learning model to facilitate automatic transmission of alerts related to ATM accessibility according to one example of the present disclosure.

FIG. 5 is a flowchart of another process for using the machine-learning model to facilitate automatic transmission of alerts related to ATM accessibility according to one example of the present disclosure.

### DETAILED DESCRIPTION

Certain aspects and examples of the present disclosure relate to an alert system for facilitating location-based, proactive transmission of alerts to user devices. The alerts can be related to automated teller machine (ATM) accessibility. For example, an ATM may be offline or may require maintenance, and therefore the ATM may be inaccessible. Additionally, the user devices can be associated with particular ATMs based on locations of the user devices and locations of the ATMs. For example, the alert system may associate a user device and an ATM based on a location of the user device and a location of the ATM being a distance apart that is less than a threshold distance. The alert system may further detect that the ATM will be inaccessible for an upcoming timeframe, such as due to scheduled maintenance for the ATM. In response to detecting that the ATM will be inaccessible, the alert system can automatically transmit an alert indicating the ATM and the upcoming timeframe to the user device. In this way, the alert system can efficiently provide information related to ATM accessibility to user devices.

In some examples, the alert system may include a location subsystem for associating the user device with one or more ATMs. For example, the location subsystem may receive a location associated the user device from a user account associated with a service provider. The user account can belong to a user of the user device, and the location received from the user account can be a zip code or address. Additionally or alternatively, the location subsystem can be permitted to access location services of the user device. Thus, in some examples, the location associated with the user device can be a physical, real-time location of the user device.

The location subsystem may further include a default distance. The location subsystem may detect the one or more ATMs associated with the user device by determining that distances between the one or more ATMs and the location associated with the user device are less than the default distance. In particular, the location subsystem may detect a circular area in which the location associated with the user device can be the center and the radius of the circular area can be the default distance. Therefore, the location subsystem may detect the one or more ATMs based on the one or more ATMs being located within the circular area.

Additionally, in some examples, the alert system can be included in or associated with a software application accessible by the user via the user device. The software application can enable the user to change the default distance to a set distance. For example, the user may adjust, via the software application, the default distance to be a set distance that is greater than the default distance to cause the alert system to provide alerts for additional ATMs. The software application may also be associated with the user account and may enable the user to change or add locations. For example, the user may update the zip code or the address associated with the user device. In another example, the user may add a second zip code or a second address. The second zip code or the second address may be associated with a place of work or other suitable location for which the user may desire alerts for nearby ATMs.

The alert system can further be configured to detect that an ATM associated with the user device is scheduled for maintenance, scheduled to be offline, experiencing a malfunction, or otherwise inaccessible for a subsequent timeframe. In response to detecting that the ATM will be inaccessible, the alert system may automatically transmit an alert to the user device. The alert can indicate the ATM by including the location of the ATM or other suitable identifying information for the ATM. The alert may also include the subsequent timeframe for when the ATM is estimated to be inaccessible. The alert may further indicate if a specific function of the ATM (e.g., deposits, withdrawals, etc.) will be inaccessible, indicate whether the ATM is located proximate to a service provider location (e.g., a bank branch) with authorized personnel, etc. Additionally, the alert can include recommendations for the user in view of the inaccessible ATM. For example, the alert system may detect an alternative ATM within the default or set distance that is or will be accessible, and, as a result, the alert transmitted may include information for the alternative ATM. In another example, the alert system may detect a service provider location within the default or set distance, and, as a result, the alert transmitted may include a recommendation that the user creates an appointment to meet with authorized personnel at the service provider location.

The alert can be transmitted as a text, an email, a push notification, or another suitable form of alert transmission. The alert may be transmitted to the user device in multiple forms. For example, the user device may receive a text and an email. Additionally, in some examples, the software application may provide alert type options for the user to select one or more preferred forms of alert transmission. For example, the user may opt to receive the alert as a text rather than as the text and the email. In examples in which the alert is transmitted as a push notification, the alert may prompt the user to perform one or more actions via a software application. For example, the push notification may prompt the user to schedule an appointment with authorization personnel at a nearby service provider location. In another example, the push notification may prompt the user to request, from the alert system, the next closest, accessible ATM. Moreover, in some examples, the alert may be displayed via a widget, such as an IOS widget or Android widget. The alerts can also be transmitted as wearable push notifications, such as to a smartwatch or other suitable wearable devices. The alert system can also be integrated with a voice assistant (e.g., Siri, Alexa, Google) associated with the user device to enable the voice assistants to relay the alert to the user.

In some examples, the alert system may further detect that the ATM is accessible after the subsequent timeframe. For example, the ATM may be offline during maintenance, and the alert system may detect that the ATM is back online after the maintenance. As a result, the alert system can transmit a follow-up alert to the user device to notify the user that the ATM is accessible.

In some examples, the alert system may also use machine-learning techniques to associate user devices and ATMs, predict user and ATM interactions, predict ATM accessibility, or otherwise facilitate the automatic, location-based transmission of alerts. For example, a first machine-learning (ML) algorithm can be trained using data for user-ATM interactions to predict a date a user may use the ATM, predict a time the user may use the ATM, predict what function of the ATM the user may use, or a combination thereof. Additionally, a second ML algorithm may be trained using data associated with ATM maintenance or inaccessibility to predict when the ATM may be inaccessible.

In current systems, determining whether an ATM is accessible can be an inefficient process. For example, in a conventional scenario, a software application or web interface can be provided that is accessible to users via the user devices. The software application or web interface may enable the users to enter a location and may detect ATMs closest to the location. The software application or web interface may further enable the users to select an ATM of interest from the ATMs closest to the location and may include an indication of whether the ATM of interest is accessible. However, the process of entering the location, selecting the ATM of interest, and checking the indication of whether the ATM of interest is accessible can be time-consuming. Therefore, there can be a need to automate the process of determining ATM accessibility and indicating the ATM accessibility to users. Additionally, for an inaccessible ATM, the software application or web interface may not indicate how long the ATM may be inaccessible or which functions (e.g., depositing funds, withdrawing funds, transferring funds, accessing account details, etc.) of the ATM are inaccessible.

Some examples of the present disclosure can overcome one or more of the abovementioned problems via an alert system that can automatically transmit alerts related to ATM accessibility to user devices. For example, the alert system may automatically detect ATMs within a threshold distance to a location associated with a user device. The alert system may further detect that one of the ATMs is inaccessible or will be inaccessible for a subsequent timeframe. As a result, the alert system can automatically transmit an alert to the user device detailing the inaccessibility of the ATM, such as by identifying the ATM. The alert may further detail the inaccessibility of the ATM by indicating when the ATM will be inaccessible, how long the ATM may be inaccessible, what functions of the ATM will be inaccessible, etc. In this way, the alert system can proactively inform users of ATM inaccessibility. Additionally, the alert system can automate the process of determining ATM accessibility and indicating the ATM accessibility to users of the user devices. The alert system can also provide important details, such as how long the ATM may be inaccessible, which functions of the ATM are inaccessible, etc.

Illustrative examples are given to introduce the reader to the general concepts. The following sections describe various additional features and examples with reference to the drawings in which like numerals indicate like elements, and directional descriptions are used to describe the illustrative aspects, but, like the illustrative aspects, should not be used to limit the present disclosure.

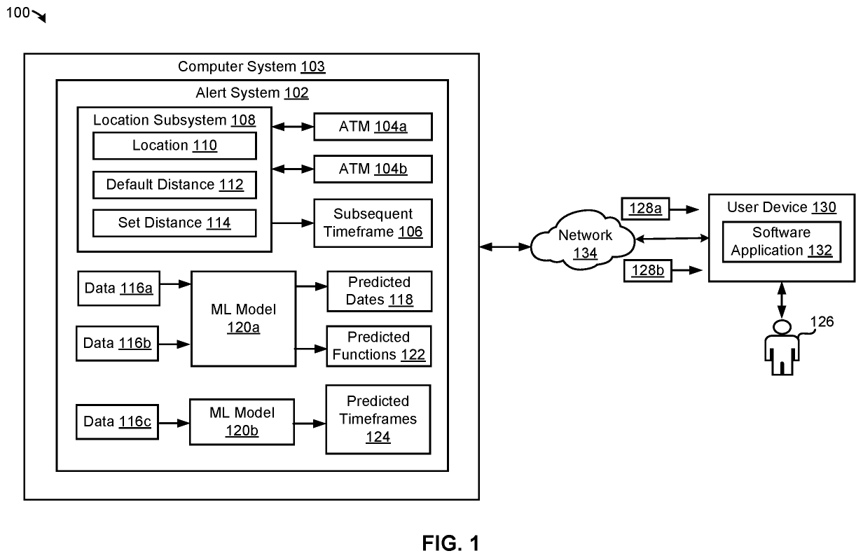

FIG. 1 is a block diagram of an example of a system 100 for automatically transmitting alerts related to automated teller machine (ATM) accessibility according to one example of the present disclosure. The system 100 includes an alert system 102 that can operate on a computer system 103. In some examples, the computer system 103 may be a distributed computer system, such as a cloud computing system or a computing cluster, formed from one or more nodes (e.g., physical or virtual servers) that are in communication with one another via a network 134. Examples of the network 134 can include a local area network or the Internet. The computer system 103 can be formed from a physical infrastructure that includes various network hardware, such as routers, hubs, bridges, switches, and firewalls. The physical infrastructure can also include one or more servers through which a user 126 can perform tasks related to the alert system 102. The servers may provide backend support for a software application 132 or may provide a web interface for enabling the user 126 to perform the tasks. The system 100 can also include a user device 130 for receiving alerts from the alert system 102 and for enabling the user 126 to interact with the software application 132 or web interface.

The alert system 102 can further include a location subsystem 108 for determining a location 110 associated with the user device 130. In an example, the user 126 associated with the user device 130 can have a user account associated with a service provider (e.g., a bank). The user account can be accessed via the software application 132 or the web interface and can include information relevant to the user 126 such as an address or zip code. The location subsystem 108 may be provided the information or may be permitted to retrieve the information. Thus, the location 110 associated with the user device 130 can be the address or the zip code. In another example, the location subsystem 108 can be permitted to access a geolocation device included in or otherwise associated with the user device 130 or location services of the user device 130. As a result, the location subsystem 108 can determine a physical, real-time location of the user device 130, which can be used for the location 110.

The alert system 102 can then detect, based on the location 110, ATMs 104a-b associated with the user device 130. In some examples, the location subsystem 108 may have access to locations of multiple ATMs. The location subsystem 108 may also have a default distance 112, which can be a distance from the location 110 below which the ATMs 104a-b can be considered sufficiently close to the user device 130. For example, the location subsystem 108 may determine that a first distance between a first location of a first ATM 104a and the location 110 is less than the default distance 112. The location subsystem 108 may also determine that a second distance between a second location of a second ATM 104b and the location 110 is less than the default distance 112. Thus, the alert system 102 can associate the ATMs 104a-b with the user device 130.

In some examples, the distance below which the ATMs 104a-b can be considered sufficiently close the user device 130 can be customizable. For example, user 126 may be able to adjust the default distance 112 via the software application 132 or the web interface to create a set distance 114. The location subsystem 108 can receive the set distance 114 and can determine that the ATMs 104a-b are associated with the user device 130 based on the locations of the ATMs 104a-b being a distance from the location 110 that is less than the set distance 114.

After detecting that the ATMs 104a-b are sufficiently close to and thereby associated with the user device 130, the alert system 102 may further monitor the accessibility of the ATMs 104a-b. For example, the alert system 102 may detect when one of the ATMs 104a-b is scheduled to be offline, has experienced an unexpected malfunction, or otherwise is or will be unavailable for a period of time. In response, to detecting that one or both of the ATMs 104a-b is or will be inaccessible, the alert system 102 can automatically transmit an alert to the user device 130 that indicates which of the ATMs 104a-b are inaccessible. The alert may also indicate when or how long the ATMs 104a-b are expected to be inaccessible.

For example, a first ATM 104a may be scheduled for maintenance. As a result, the alert system 102 may detect that the maintenance is scheduled for a subsequent date and at a particular time (e.g., 2:00 PM). The alert system 102 may further determine that an estimated length of time for the maintenance is six hours. Thus, the alert system 102 can transmit a first alert 128a to the user device 130. The first alert 128a can include a first indication of the first ATM 104a (e.g., a location of the first ATM 104a or other suitable identifying information for the first ATM 104a) and a second indication of a subsequent timeframe 106 for which the first ATM 104a is estimated to be inaccessible. The second indication may include the subsequent date, the particular time, the estimated length of time, or a combination thereof.

Additionally, the first alert 128a may be transmitted as a text, an email, a push notification from the software application 132, or in another suitable form of alert transmission. In some examples, the first alert 128a may include alternative actions for the user 126 in view of the first ATM 104a being inaccessible during the subsequent timeframe 106. For example, the alert system 102 can be integrated with a navigation system (e.g., Google Maps, Apple Maps, etc.). Therefore, the first alert 128a may indicate that the second ATM 104b, also associated with the user device 130, will be accessible during the subsequent timeframe 106. The first alert 128a may further include a link or other suitable mechanism to enable the user device 130 to automatically access the navigation system with directions to the second ATM 104b. In another example, the first alert 128a can include a link or other suitable mechanism to enable the user device 130 to access the software application 132, through which the user 126 may set up an appointment with authorized personnel associated with the service provider. The appointment can be an alternative method of completing functions commonly performed via the ATMs 104a-b, such as withdrawing funds, depositing funds, transferring funds, accessing account details, etc.

Additionally, in some examples, machine-learning (ML) techniques can be implemented to control the transmission of alerts by the alert system 102. For example, a first ML model 120a can be trained to output one or more predicted dates 118 for when the user 126 may access the ATMs 104a-b. The first ML model 120a may also be trained to output one or more predicted functions 122 of the ATMs 104a-b that the user 126 may use on the predicted dates 118. Thus, the alert system 102 may transmit alerts based on the ATMs 104a-b being inaccessible during the predicted dates 118, based on the predicted functions 122 being inaccessible, or a combination thereof.

In an example, first data 116a indicating a plurality of dates that the user 126 has previously accessed the first ATM 104a can be input into the first ML model 120a. As a result, the first ML model 120a may output the predicted dates 118 for subsequent access to the first ATM 104a by the user 126. The first ML model 120a may predict the dates based on patterns in the first data 116a. For example, the first ML model 120a may predict one or more days of the week that the user 126 may access the first ATM 104a and a frequency of the access (e.g., weekly, monthly, quarterly, etc.) Thus, in the example, the first ML model 120a may predict that the user 126 will access the first ATM 104a on the last Friday of each month. The alert system 102, may further detect that the one of the predicted dates 118 corresponds to the subsequent timeframe 106 that the first ATM 104a is inaccessible due to the maintenance. As a result, the alert system 102 can automatically transmit the first alert 128a to the user device 130. In an alternative example in which the predicted dates 118 do not correspond to the subsequent timeframe 106, the alert system 102 may not transmit an alert to the user device 130. Therefore, the ML techniques can enable the alert system 102 to provide highly relevant and customized alerts to the user device 130.

Additionally, second data 116b can indicate one or more functions of the first ATM 104a that the user 126 accessed on each date of the plurality of dates. The second data 116b can be input into the first ML model 120a. In response, the first ML model 120a may output the predicted functions 122 for the subsequent access to the first ATM 104a by the user 126. The first ML model 120a may predict the functions based on patterns in the second data 116b. Thus, in the example, the first ML model 120a may predict that the user 126 will deposit funds at the first ATM 104a on the last Friday of each month. The alert system 102 may detect that, at the subsequent timeframe 106, a function of the first ATM 104a for depositing funds will be unavailable. As a result, the alert system 102 can automatically transmit the first alert 128a to the user device 130. In an alternative example in which it is detected that the predicted functions 122 are accessible at the subsequent timeframe 106, the alert system 102 may not transmit an alert to the user device 130. Thus, the ML techniques can further enable the alert system 102 to provide highly relevant and customized alerts to the user device 130.

Additionally, in some examples, the alert system 102 may detect that an ATM is available following a subsequent timeframe for which the ATM was unavailable. For example, the alert system 102 may detect when the maintenance has been performed and the first ATM 104a is back online. In response, the alert system 102 may transmit a second alert 128b to the user device 130 indicating that the first ATM 104a is accessible.

Additionally, a second ML model 120b can be trained to predict when an ATM may be inaccessible based on historical data related to ATM maintenance, malfunctions, etc. Thus, in an example, the alert system 102 may input the third data 116c associated with previous inaccessibility of the ATMs 104a-b or of ATMs of a similar type, version, etc. to the ATMs 104a-b into the second ML model 120b. In response, the second ML model 120b can output one or more predicted timeframes 124 for when the ATMs 104a-b may be inaccessible based on the third data 116c. The alert system 102 may transmit alerts based on the predicted timeframes 124. For example, the alert system 102 may compare the predicted timeframes 124 to the predicted dates 118 of the first ML model 120a and may transmit an alert based on a particular predicted timeframe corresponding to a particular predicted date.

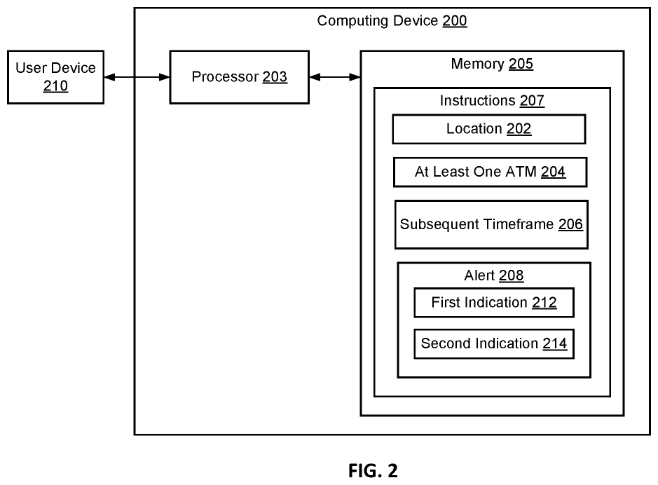

FIG. 2 is a block diagram of an example of a computing device 200 for automatically transmitting alerts related to automated teller machine (ATM) accessibility according to one example of the present disclosure. As depicted, the computing device 200 may include a processor 203 communicatively coupled to a memory 205. In some examples, the components shown in FIG. 2 can be integrated into a single structure. For example, the components can be within a single housing. In other examples, the components shown in FIG. 2 can be distributed (e.g., in separate housings) and in electrical communication with each other.

The processor 203 can execute one or more operations for implementing some examples. The processor 203 can execute instructions 207 stored in the memory 205 to perform the operations. The processor 203 can include one processing device or multiple processing devices. Non-limiting examples of the processor 203 include a Field-Programmable Gate Array (“FPGA”), an application-specific integrated circuit (“ASIC”), a microprocessor, etc. In some examples, the instructions 207 can include processor-specific instructions generated by a compiler or an interpreter from code written in any suitable computer-programming language, such as C, C++, C#, Python, or Java.

The memory 205 can include one memory or multiple memories. The memory 205 can be non-volatile and may include any type of memory that retains stored information when powered off. Non-limiting examples of the memory 205 include electrically erasable and programmable read-only memory (EEPROM), flash memory, or any other type of non-volatile memory. At least some of the memory 205 can be a non-transitory, computer-readable medium from which the processor 203 can read the instructions 207. A computer-readable medium can include electronic, optical, magnetic, or other storage devices capable of providing the processor 203 with computer-readable instructions or other program code. Non-limiting examples of a computer-readable medium include magnetic disk(s), memory chip(s), ROM, random-access memory (RAM), an ASIC, a configured processor, optical storage, or any other medium from which the processor 203 can read the instructions 207.

The processor 203 can execute the instructions 207 to perform operations. For example, the processor 203 can detect, based on a location 202 associated with a user device 210, at least one ATM 204 associated with the user device 210. The processor 203 can also determine that the at least one ATM 204 will be inaccessible for a subsequent timeframe 206. Additionally, the processor 203 can transmit, to the user device 210, an alert 208 to notify a user of the user device 210 that the at least one ATM 204 will be inaccessible. The alert 208 can include a first indication 212 of the at least one ATM 204 and a second indication 214 of the subsequent timeframe 206.

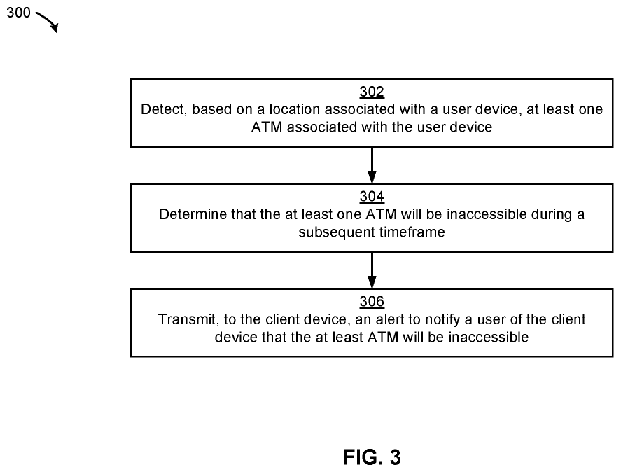

FIG. 3 is a flowchart of a process 300 for automatically transmitting alerts related to automated teller machine (ATM) accessibility according to one example of the present disclosure. The process 300 of FIG. 3 can be implemented by the alert system 102 of FIG. 1 or the computing device 200 of FIG. 2, but other implementations are also possible. While FIG. 3 depicts a certain sequence of steps for illustrative purposes, other examples can involve more steps, fewer steps, different steps, or a different order of the steps depicted in FIG. 3. The steps of FIG. 3 are described below with reference to the components of FIGS. 1-2 described above.

At block 302, the processor 203 detects, based on a location 110 associated with a user device 130, at least one ATM 104a-b associated with the user device 130. The processor 203 may be executing the alert system 102, which can include a location subsystem 108 for detecting the ATMs 104a-b associated with the user device 130 based on the location 110. The location 110 may be an address associated with a user account belonging to a user 126 of the user device 130 or the location 110 may be a physical, real-time location of the user device 130.

Additionally, the ATMs 104a-b can be associated with the user device 130 based on a distance between the ATMs 104a-b and the location 110 being less than a threshold distance. For example, the processor 203 may determine or receive a default distance 112. Then, the processor 203 may determine that a first distance between a first ATM 104a and the location 110 associated with the user device 130 is less than the default distance 112. Similarly, the processor 203 may determine that a second distance between a second ATM 104b and the location 110 associated with the user device 130 is less than the default distance 112. Thus, the ATMs 104a-b can be associated with the user device 130 based on the first and second distances being less than the default distance 112.

In another example, the processor 203 may receive a set distance 114. The set distance 114 can be set by the user 126 via the user device 130 and can be different than the default distance 112. Thus, the processor 203 may determine that a third distance between the first ATM 104a and the location 110 is less than the set distance 114, and the processor 203 may determine that a fourth distance between the second ATM 104b and the location 110 is less than the set distance 114. Due to the third and fourth distances being less than the set distance 114, the ATMs 104a-b can be associated with the user device 130.

At block 304, the processor 203 determines that the at least one ATM 104a-b will be inaccessible during a subsequent timeframe 106. The processor 203 may be executing the alert system 102 to determine that one or both of the ATMs 104a-b may be inaccessible during the subsequent timeframe 106. The ATMs 104a-b can be inaccessible due to maintenance, a malfunction, etc. Additionally, in some examples, the processor 203 may implement machine-learning (ML) techniques to predict the subsequent timeframe 106 that the ATMs 104a-b may be inaccessible. For example, the processor 203 may input, into a second ML model 120b, third data 116c associated with previous inaccessibility of the ATMs 104a-b. Then, the processor 203 can output, via the second ML model 120b, one or more predicted timeframes 124 for when one or both of the ATMs 104a-b may be inaccessible based on the third data 116c.

At block 306, the processor 203 transmits, to the user device 130, an alert 208 to notify a user 126 of the user device 130 that the at least one ATM 104a-b will be inaccessible. The processor 203 may be executing the alert system 102 to transmit the alert 208. Additionally, the processor 203 may transmit the alert 208 in response to detecting that one or both of the ATMs 104a-b will be inaccessible during the subsequent timeframe 106 or in response to the predicted timeframes 124 provided by the second ML model 120b. In this way, the processor 203 can automatically transmit the alert 208 to the user device 130 to proactively inform the user 126 of inaccessibility of the ATMs 104a-b.

Additionally, the alert 208 can include a first indication 212 of the at least one ATM 104a-b and a second indication 214 the subsequent timeframe 106. The first indication may include a location of the ATMs 104a-b that are inaccessible or other suitable identifying information for the ATMs 104a-b. The second indication may include one or more subsequent dates for the inaccessibility, a length of time for when the ATMs 104a-b may be inaccessible, or other suitable information about the subsequent timeframe 106 for which the ATMs 104a-b may be inaccessible.

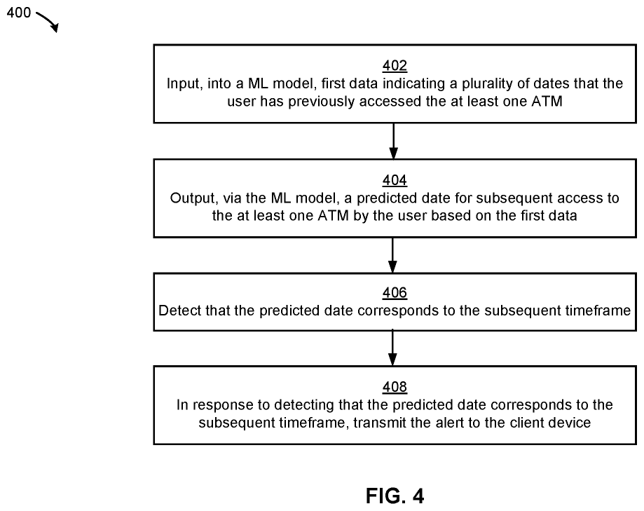

FIG. 4 is a flowchart of a process 400 for using a machine-learning (ML) model to facilitate automatic transmission of alerts related to automated teller machine (ATM) accessibility according to one example of the present disclosure. The process 400 of FIG. 4 can be implemented by the alert system 102 of FIG. 1 or the computing device 200 of FIG. 2, but other implementations are also possible. While FIG. 4 depicts a certain sequence of steps for illustrative purposes, other examples can involve more steps, fewer steps, different steps, or a different order of the steps depicted in FIG. 4. The steps of FIG. 4 are described below with reference to the components of FIGS. 1-2 described above.

At block 402, the processor 203 inputs, into the ML model, first data 116a indicating a plurality of dates that the user 126 has previously accessed the at least one ATM 104a-b. In an example, the ML model can be a first ML model 120a and the first data 116a can indicate a plurality of dates that the user 126 has previously accessed the ATMs 104a-b. The first ML model 120a can be trained to predict dates for which the user 126 may subsequently access the first ATM 104a based on the first data 116a. In some examples, the first data 116a can further include timestamps for the plurality of dates that the user 126 previously accessed the ATMs 104a-b. Thus, the first ML model 120a may be trained to also predict a time or period of time in which the user 126 may subsequently access the first ATM 104a.

At block 404, the processor 203 outputs, via the ML model, a predicted date 118 for subsequent access to the at least one ATM 104a-b by the user 126 based on the first data 116a. In the example, the first ML model 120a may output the predicted date 118 based on patterns in the first data 116a. For example, the first ML model 120a may detect a pattern in which the user 126 uses the first ATM 104a on Monday most weeks. Therefore, the predicted date 118 may be the subsequent Monday to the present date. In some examples, the processor 203 may also output, via the first ML model 120a, a predicted time or period of time for the subsequent access to the first ATM 104a by the user 126 based on the first data 116a. For example, the first ML model 120a may predict that the user 126 will access the first ATM 104a between 5:00 PM and 8:00 PM on the subsequent Monday.

At block 406, the processor 203 detects that the predicted date 118 corresponds to the subsequent timeframe 106. For example, a service provider associated with the first ATM 104a may be performing a system update at the subsequent timeframe 106. The processor 203 may detect that the first ATM 104a may be offline during the system update, and therefore may be inaccessible. Thus, the subsequent timeframe 106 can be the estimated timeframe for the system update. The processor 203 may further detect that the predicted date 118 of the subsequent Monday corresponds to the subsequent timeframe 106 of the system update.

At block 408, the processor 203, in response to detecting that the predicted date 118 corresponds to the subsequent timeframe 106, transmits the alert 208 to the user device 130. Thus, the processor 203 may transmit alerts based on the inaccessibility of ATMs 104a-b being associated with when the user 126 typically uses the ATMs 104a-b. In this way, the processor 203 can provide highly relevant alerts to the user device 130. Additionally, the alert 208 can provide additional information, such as information for a second ATM 104b that may be accessible during the subsequent timeframe 106.

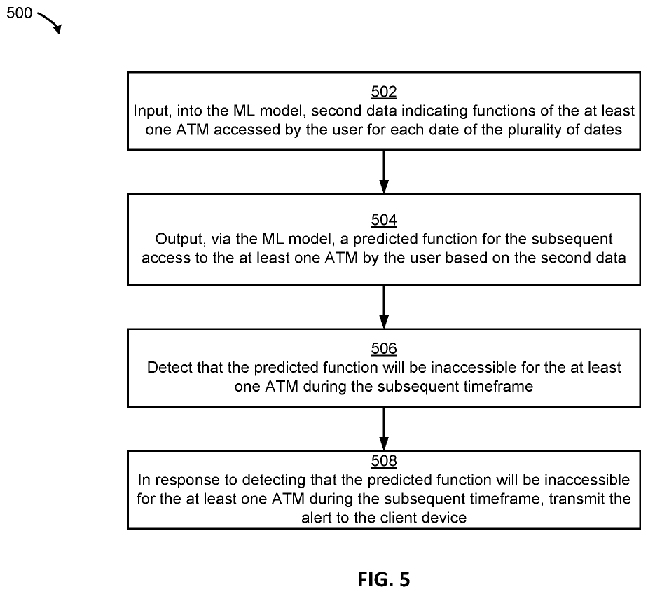

FIG. 5 is a flowchart of a process 500 for using the machine-learning (ML) model to facilitate automatic transmission of alerts related to automated teller machine (ATM) accessibility according to one example of the present disclosure. The process 500 of FIG. 5 can be implemented by the alert system 102 of FIG. 1 or the computing device 200 of FIG. 2, but other implementations are also possible. While FIG. 5 depicts a certain sequence of steps for illustrative purposes, other examples can involve more steps, fewer steps, different steps, or a different order of the steps depicted in FIG. 5. The steps of FIG. 5 are described below with reference to the components of FIGS. 1-2 described above.

At block 502, the processor 203 inputs, into the ML model, second data 116b indicating functions of the at least one ATM 104a-b accessed by the user 126 for each date of the plurality of dates. In an example, the ML model can be a first ML model 120a and first data 116a can indicate a plurality of dates that the user 126 has previously accessed the ATMs 104a-b. Then, the second data 116b can indicate one or more functions of the ATMs 104a-d used by the user 126 at the plurality of dates. Additionally, the first ML model 120a can be trained to predict dates for which the user 126 may subsequently access the first ATM 104a based on the first data 116a and may further predict functions that the user 126 may use at the predicted dates based on the second data 116b.

At block 504, the processor 203 outputs, via the ML model, a predicted function 122 for the subsequent access to the at least one ATM 104a-b by the user 126 based on the second data 116b. In the example, the first ML model 120a may output the predicted date 118 based on patterns in the first data 116a. For example, the first ML model 120a may detect a pattern in which the user 126 uses the first ATM 104a on first day of each month. Thus, the processor 203 can output a predicted date 118 of the first day of the next month. The processor 203 may also output, via the first ML model 120a, the predicted function 122 for the predicted date 118. For example, the first ML model 120a may predict that the user 126 will use the first ATM 104a to withdraw funds on the predicted date 118.

At block 506, the processor 203 detects that the predicted function 122 will be inaccessible for the at least one ATM 104a-b during the subsequent timeframe 106. For example, a service provider associated with the first ATM 104a may be performing a system update at the subsequent timeframe 106. The processor 203 may detect that some functions of the first ATM 104a may be inaccessible during the system update. For example, a first function for withdrawing funds and a second function for depositing funds may be inaccessible during the subsequent timeframe 106, while a third function for checking an account balance may be accessible during the subsequent timeframe 106. Thus, the processor 203 may detect that the predicted date 118 of the subsequent Monday corresponds to the subsequent timeframe 106 and that the predicted function 122 corresponds to first function.

At block 508, the processor 203, in response to detecting that the predicted function 122 will be inaccessible for the at least one ATM 104a-b during the subsequent timeframe 106, transmits the alert 208 to the user device 130. Thus, the processor 203 may transmit alerts based on the inaccessibility being relevant to when and how the user 126 typically uses the ATMs 104a-b. In this way, the processor 203 can provide highly relevant alerts to the user device 130.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processor; and
a memory that includes instructions executable by the processor for causing the processor to perform operations comprising:
detecting, based on a location associated with a user device, at least one automated teller machine (ATM) associated with the user device;
determining that the at least one ATM will be inaccessible for a subsequent timeframe; and
transmitting, to the user device, an alert to notify a user of the user device that the at least one ATM will be inaccessible, the alert comprising a first indication of the at least one ATM and a second indication of the subsequent timeframe.

2. The system of claim 1, wherein the operation of detecting, based on the location associated with the user device, the at least one ATM associated with the user device further comprises:
determining a first distance, the first distance being a default distance for detecting the at least one ATM; and
determining that a second distance between the at least one ATM and the location associated with the user device is less than the first distance.

3. The system of claim 2, wherein the operation of detecting, based on the location associated with the user device, the at least one ATM associated with the user device further comprises:
receiving, from the user device, a third distance, the third distance being different from the first distance; and
determining that the second distance between the at least one ATM and the location associated with the user device is less than the third distance.

4. The system of claim 1, wherein the memory further includes instructions executable by the processor for causing the processor to perform operations comprising:
inputting, into a machine-learning model, first data indicating a plurality of dates that the user has previously accessed the at least one ATM;
outputting, via the machine-learning model, a predicted date for subsequent access to the at least one ATM by the user based on the first data;
detecting that the predicted date corresponds to the subsequent timeframe; and
in response to detecting that the predicted date corresponds to the subsequent timeframe, transmitting the alert to the user device.

5. The system of claim 4, wherein the memory further includes instructions executable by the processor for causing the processor to perform operations comprising:
inputting, into the machine-learning model, second data indicating one or more functions of the at least one ATM accessed by the user for each date of the plurality of dates, wherein the one or more functions of the at least one ATM include depositing funds, withdrawing funds, transferring funds, or accessing account details;
outputting, via the machine-learning model, a predicted function for the subsequent access to the at least one ATM by the user based on the second data;
in addition to detecting that the predicted date corresponds to the subsequent timeframe, detecting that the predicted function will be inaccessible for the at least one ATM during the subsequent timeframe; and
in response to detecting that the predicted function will be inaccessible during the subsequent timeframe, transmitting the alert to the user device.

6. The system of claim 1, wherein the operation of determining that the at least one ATM will be inaccessible during the subsequent timeframe further comprises:
inputting, into a machine-learning model, data associated with previous inaccessibility of the at least one ATM; and
outputting, via the machine-learning model, a predicted timeframe for when the at least one ATM will be inaccessible based on the data.

7. The system of claim 1, wherein the alert is a first alert and wherein the memory further includes instructions executable by the processor for causing the processor to perform operations comprising:
determining, after the subsequent timeframe, that the at least one ATM is accessible; and
transmitting, to the user device, a second alert to notify the user of the user device that the at least one ATM is accessible.

8. A computer-implemented method comprising:
detecting, based on a location associated with a user device, at least one ATM associated with the user device;
determining that the at least one ATM will be inaccessible for a subsequent timeframe; and
transmitting, to the user device, an alert to notify a user of the user device that the at least one ATM will be inaccessible, the alert comprising a first indication of the at least one ATM and a second indication of the subsequent timeframe.

9. The computer-implemented method of claim 8, wherein detecting, based on the location associated with the user device, the at least one ATM associated with the user device further comprises:
determining a first distance, the first distance being a default distance for detecting the at least one ATM; and
determining that a second distance between the at least one ATM and the location associated with the user device is less than the first distance.

10. The computer-implemented method of claim 9, wherein detecting, based on the location associated with the user device, the at least one ATM associated with the user device further comprises:
receiving, from the user device, a third distance, the third distance being different from the first distance; and
determining that the second distance between the at least one ATM and the location associated with the user device is less than the third distance.

11. The computer-implemented method of claim 8, further comprising:
inputting, into a machine-learning model, first data indicating a plurality of dates that the user has previously accessed the at least one ATM;
outputting, via the machine-learning model, a predicted date for subsequent access to the at least one ATM by the user based on the first data;
detecting that the predicted date corresponds to the subsequent timeframe; and
in response to detecting that the predicted date corresponds to the subsequent timeframe, transmitting the alert to the user device.

12. The computer-implemented method of claim 11, further comprising:
inputting, into the machine-learning model, second data indicating one or more functions of the at least one ATM accessed by the user for each date of the plurality of dates, wherein the one or more functions of the at least one ATM include depositing funds, withdrawing funds, transferring funds, or accessing account details;
outputting, via the machine-learning model, a predicted function for the subsequent access to the at least one ATM by the user based on the second data;
in addition to detecting that the predicted date corresponds to the subsequent timeframe, detecting that the predicted function will be inaccessible for the at least one ATM during the subsequent timeframe; and
in response to detecting that the predicted function will be inaccessible during the subsequent timeframe, transmitting the alert to the user device.

13. The computer-implemented method of claim 8, wherein determining that the at least one ATM that will be inaccessible during the subsequent timeframe further comprises:
inputting, into a machine-learning model, data associated with previous inaccessibility of the at least one ATM; and
outputting, via the machine-learning model, a predicted timeframe for when the at least one ATM will be inaccessible based on the data.

14. The computer-implemented method of claim 8, wherein the alert is a first alert and wherein the computer-implemented method further comprises:
determining, after the subsequent timeframe, that the at least one ATM is accessible; and
transmitting, to the user device, a second alert to notify the user of the user device that the at least one ATM is accessible.

15. A non-transitory computer-readable medium comprising instructions that are executable by a processor for causing the processor to perform operations comprising:
detecting, based on a location associated with a user device, at least one ATM associated with the user device;
determining that the at least one ATM will be inaccessible for a subsequent timeframe; and
transmitting, to the user device, an alert to notify a user of the user device that the at least one ATM will be inaccessible, the alert comprising a first indication of the at least one ATM and a second indication of the subsequent timeframe.

16. The non-transitory computer-readable medium of claim 15, wherein the operation of detecting, based on the location associated with the user device, the at least one ATM associated with the user device further comprises:
determining a first distance, the first distance being a default distance for detecting the at least one ATM; and
determining that a second distance between the at least one ATM and the location associated with the user device is less than the first distance.

17. The non-transitory computer-readable medium of claim 16, wherein the operation of detecting, based on the location associated with the user device, the at least one ATM associated with the user device further comprises:
receiving, from the user device, a third distance, the third distance being different from the first distance; and
determining that the second distance between the at least one ATM and the location associated with the user device is less than the third distance.

18. The non-transitory computer-readable medium of claim 15, further comprising instructions that are executable by the processor for causing the processor to:
input, into a machine-learning model, first data indicating a plurality of dates that the user has previously accessed the at least one ATM;
output, via the machine-learning model, a predicted date for subsequent access to the at least one ATM by the user based on the first data;
detect that the predicted date corresponds to the subsequent timeframe; and
in response to detecting that the predicted date corresponds to the subsequent timeframe, transmit the alert to the user device.

19. The non-transitory computer-readable medium of claim 18, further comprising instructions that are executable by the processor for causing the processor to:
input, into the machine-learning model, second data indicating one or more functions of the at least one ATM accessed by the user for each date of the plurality of dates, wherein the one or more functions of the at least one ATM include depositing funds, withdrawing funds, transferring funds, or accessing account details;
output, via the machine-learning model, a predicted function for the subsequent access to the at least one ATM by the user based on the second data;
in addition to detecting that the predicted date corresponds to the subsequent timeframe, detect that the predicted function will be inaccessible for the at least one ATM during the subsequent timeframe; and
in response to detecting that the predicted function will be inaccessible during the subsequent timeframe, transmit the alert to the user device.

20. The non-transitory computer-readable medium of claim 15, wherein the operation of determining that the at least one ATM that will be inaccessible during the subsequent timeframe further comprises:
inputting, into a machine-learning model, data associated with previous inaccessibility of the at least one ATM; and
outputting, via the machine-learning model, a predicted timeframe for when the at least one ATM will be inaccessible based on the data.
